(19) United States
(12) Patent Application Publication
(10) Pub. No.: US 2009/0322866 A1
(43) Pub. Date: Dec. 31, 2009

(54) SECURITY CHECKPOINT SYSTEMS AND METHODS

(75) Inventors: Sarah Christine Maas Stotz, Wilton, NY (US); Peter Henry Tu, Niskayuna, NY (US); Hoke Smith Trammell, III, SanDiego, CA (US); Peter Victor Czipott, San Diego, CA (US); Yotam Margalit, Castro Valley, CA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/737,155

(22) Filed: Apr. 19, 2007

(51) Int. Cl. H04N 7/18; G06K 9/00

(52) U.S. Cl. 348/77; 382/118; 348/E07.085

(57) ABSTRACT

Embodiments of the invention include a security checkpoint system that has a camera configured for obtaining a first photographic image of an individual, a photographic image scanner configured for scanning a second photographic image, and a comparator mechanism for comparing the first photographic image with the second photographic image to ascertain whether the second photographic image is of the individual. Other embodiments include a method for automatedly developing security-related characteristics for an individual.

### BACKGROUND

The invention generally relates to security checkpoints and the mechanisms used therein, and more particularly, to an autonomous security kiosk for self-service procession through a security screening process.

There are numerous locations worldwide in which the need for security personnel to process and screen individuals. For example, in the United States alone, there are greater than 400 airports, each one of which has one or more security checkpoint areas that are manned by security guards. Taking the airport example, security guards are tasked with identifying passengers by photo identifiers, such as driver's licenses or passports, manually checking boarding cards to verify that the passengers are rightfully attempting to enter a controlled airport area.

Errors in identification can occur through this current practice. Aging photographs, changes in appearance like facial hair, eyewear, and hairstyle can cause such errors. Further, forged or false documents may be difficult to detect through a manual inspection.

Additionally, many passengers at airports are becoming accustomed to interfacing with quick and efficient aviation kiosks for a variety of services, such as obtaining boarding cards.

### SUMMARY

One embodiment of the invention described herein is directed to a security checkpoint system that includes a camera configured for obtaining a first photographic image of an individual, a photographic image scanner configured for scanning a second photographic image, and a comparator mechanism for comparing the first photographic image with the second photographic image to ascertain whether the second photographic image is of the individual.

Another embodiment of the invention is directed to a kiosk for autonomous interface by an individual. The kiosk includes an identification verification modality and at least one additional security-related modality. The identification verification modality includes an image formation system for obtaining a first photographic image of an individual, a scanning system for scanning a second photographic image, and a comparison system for comparing the first photographic image with the second photographic image to ascertain whether the second photographic image is of the individual.

Another embodiment of the invention is a method for automatedly developing security-related characteristics for an individual. The method includes obtaining a first photographic image of the individual, scanning a second photographic image provided by the individual, and comparing the first photographic image with the second photographic image to ascertain whether the second photographic image is of the individual.

These and other advantages and features will be more readily understood from the following detailed description of preferred embodiments of the invention that is provided in connection with the accompanying drawings.

### BRIEF DESCRIPTION OF THE DRAWINGS

FIG. 1 is a perspective view of a security checkpoint system constructed in accordance with an embodiment of the invention.

FIG. 2 is a schematic view of hardware components for use in the system of FIG. 1.

FIG. 3 is a schematic view of software for use in the system of FIG. 1.

FIGS. 4A and 4B are a schematic view illustrating a security checking process in accordance with an embodiment of the invention.

### DETAILED DESCRIPTION OF PREFERRED EMBODIMENTS

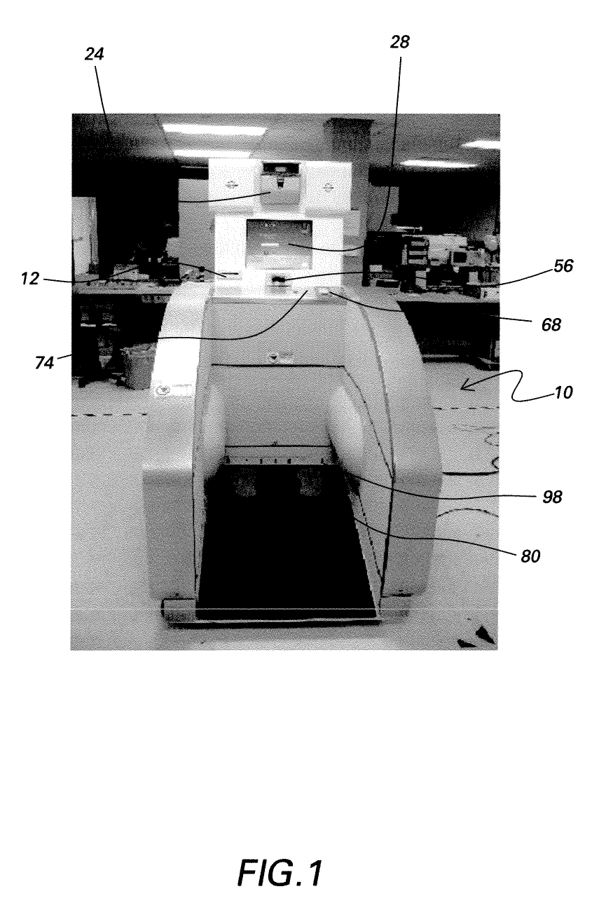

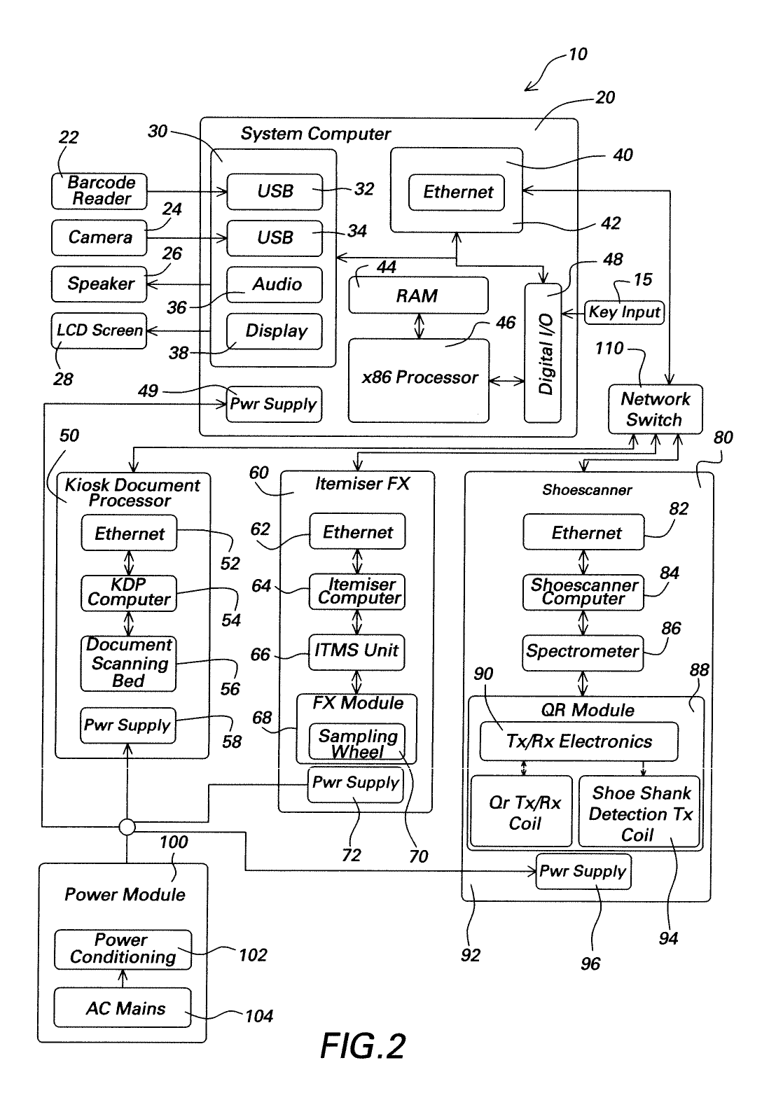

Referring to FIGS. 1 and 2, there is shown a kiosk 10 for autonomous interaction with individuals. The kiosk 10 includes one or more modalities related to ascertaining and ascribing security-related characteristics to individuals. Such kiosks 10 may find usefulness in locations where individuals must undergo security screening, such as, for example, airports and cruise ships. Other locations where such kiosks 10 may be used are at military installations, government buildings, embassies, corporate locations employing large workforces, bus terminals, train stations, hotels, sporting arenas, etc. Further, such kiosks 10 may incorporate functions found in other autonomous kiosks, such as, for example, printing off boarding passes through the use of a printer 12.

The kiosk 10 includes a computer system 20 and a document processing system 50. The kiosk 10 may further include a trace detection system 60 and a shoe scanning system 80. The document processing system 50, the trace detection system 60, and the shoe scanning system 80 interact with the computer system 20 through a network switch 110.

The computer system 20 includes a barcode reader 22, a camera 24, a speaker 26, and a display screen 28. Each of the aforementioned components interacts with an on-board interface 30. Specifically, the barcode reader 22 interacts with USB 32, the camera 24 interacts with USB 34, the speaker 26 interacts with an audio component 36, and the display screen 28 interacts with a display component 38. The computer system 20 further includes a second on-board interface 40 that includes an Ethernet component 42, which interacts with the network switch 110.

Interaction by an individual with the kiosk 10 is, at least initially, accomplished through a key input device 15, which interacts with a digital input/output component 48. The key input device 15 may be any suitable inputting device, such as, for example, a touch pad, a touch screen, or a keyboard. The digital input/output component 48 interfaces with a processor 46, which in turn interfaces with random memory 44. A power supply 49 supplies power to the computer system 20.

Numerous security-related assessments can be performed at the kiosk 10. For example, the identity of an individual can be ascertained, based upon a comparison of the individual's current appearance and proffered documents. Also, the authenticity of proffered documents also can be determined. Additionally, a scan can be performed to ascertain whether an individual has contraband in his shoes or has any trace elements of interest on his person.

It is envisioned that an individual will use the key input pad 15 to begin interaction with the kiosk 10. The individual's interaction with the kiosk 10 may include authenticating the individual's identity, authenticating the individual's documentation, determining whether the individual has trace elements of controlled substances on his/her person, and determining whether any contraband items are located in the individual's shoes.

Next will be described a process for identifying an individual. Processing, validation and authentication of an individual's identification is often crucial in confirming the individual's identity. For example, airline passengers must undergo fairly rigorous security screening prior to being allowed on an airplane. Part of that screening process includes ascertaining that the passenger is on the right flight, is who the presented identification documents purports him/her to be, and is not carrying any banned substance. A passenger's identity is required not only for matching the passenger with the information on the airline's reservation system, but also to eliminate the possible use of false or forged documentation.

To ascertain that the individual is the same person as identified on the proffered identification documents, the kiosk 10 will obtain the individual's name and other identification information. The kiosk 10 also will direct the individual, through the speaker 26, to stand in a particular location and look in a particular direction so that the camera 24 can take a photograph of the individual. The camera 24 may be a digital camera or a digital video recorder. Alternatively, the camera 24 may be an analog camera or an analog video recorder, coupled with an analog-to-digital converter to convert analog images into digital images. Contemporaneously therewith, the kiosk 10 will direct the individual to place his standard or non-standard identification documents, e.g., passport or state-issued drivers license, on the document scanning bed 56. Discriminative models are then applied to the photograph taken of the individual by the camera 24 and on the scanned image taken by the document scanning bed 56.

The computer processor 46 processes the information provided by the discriminative models to analyze whether the scanned image and the photograph are similar enough to determine that the scanned image is of the individual. The computer component 46 also can process additional information on any given document, such as the individual's age, the date of the document, the gender of the individual, and the type of identifying document. Using this information as parameters in discriminative modeling allows for a more robust approach.

Furthermore, the facial recognition modality can be made to be adaptive. The facial recognition modality determines verification as being either a valid match or an invalid match. Given sufficient training data, a form of statistical boosting may be used to automatically determine an appropriate mechanism for discriminating between valid and invalid matches. Additionally, the training data may be partitioned into various classes, for example, males aged 34 to 38 with identification documents that are between four and six years old. By such partitioning and by the automatic generation of discriminative models, thousands of data-driven verification engines may be manufactured in a systematic fashion, resulting in a mechanism having a capacity for greater specificity.

Next will be described a process for authenticating an individual's documentation. The document processing system 50 is powered with a power supply 58. The document processing system 50 includes a document scanning bed 56, which interacts with a computer component 54. The document processing system 50 also includes an Ethernet component 52, which also interacts with the computer component 54.

The document processing system 50 can be used to ascertain the veracity and authenticity of the proffered identification documents. The document scanning bed 56 may be incorporated with various illumination modules to determine whether the scanned document is authentic or a forgery. Near-infrared illumination modules and/or ultraviolet illumination modules are examples of illumination modules that may be incorporated within the document scanning bed 56 to determine the authenticity of scanned documents. Personal information displayed on the proffered document is extracted from images taken in visible light (to create a color image) and near-infrared light (to create an image that contains the excited-reflection of the ink. Recognition of the data in the visible inspection zone and the machine readable zone, comparison of the data between these zones, and matching of the data to published standards, such as the International Civil Aviation Organization (ICAO), assist in determining the authenticity of the proffered document. Illumination by ultraviolet light assists in identifying irregularities in absorption and luminescence in the image, thus helping to determine the authenticity of the proffered document.

It should be appreciated that the kiosk 10 may incorporate services such as e-ticketing and printing of boarding cards. Such a kiosk 10 also may include a boarding card reader for reading a boarding card to ensure that the passenger is the person intended to board a specific flight. Automatic inspection of boarding cards through a boarding pass scanner 74 (FIG. 1) may result in a savings of time in the security process and increased effectiveness by reducing human error due to a person examining the boarding cards. The boarding pass scanner 74 may be configured to read both older one-dimensional bar codes as well as newer PDF417 two-dimensional codes.

The trace detection system 60, which is powered by a power supply 72, includes an interface 68. The interface 68, which may include a sampling wheel 70, interacts with an ion mobility trap system unit 66, which in turn interacts with a computer component 64. The trace detection system 60 also includes an Ethernet component 62, which also interacts with the computer component 64. The computer component 64 may incorporate a trace element detecting component capable of detecting trace elements of explosives material, narcotics, or other contraband through direct transfer. The trace element detecting component may use ion trap mobility spectrometry technology to detect and identify substances of interest at levels in the picogram range and above. Such a component may be an ITEMISER™ FX manufactured and marketed by GE Homeland Protection, Inc. of Newark, Calif. When an individual touches the interface 68, which may include a “start” button, residue from the finger of the individual is inspected for trace amounts of the aforementioned substances. While described in terms of a “button”, it should be appreciated that the initiation of the trace element detecting action may be done through a keyboard, a touchpad, a touch screen, or any other suitable device.

The “start” button on the interface 68 may be included within the key input device 15 and may be mounted on a wheel, such as the sampling wheel 70, that takes the residue from the finger to a heater. The heater desorbs and vaporizes the residue. Compounds within the vapor are ionized and introduced, with a buffer gas, into a drift chamber containing an electric field. The ions, accelerated by the electric field, drift through the buffer gas at different speeds depending upon their size and shape. Eventually, they deposit their charges on a collector electrode at a far end of the drift chamber. The time between the entry of the ions into the drift chamber and their impact on the collector electrode is a measured parameter identifying a given compound or constituents of a mixture. Charge collecting on the collector electrode accomplishes detection. Comparing the time series of charge accumulation with a time series stored in a database of known compounds/mixtures of interest enables identification of the compound or mixture in the finger residue. A match within the database triggers an alert, which is invisible to the individual. As an option, a software switch can be employed to allow the trace detection system 60 to alert on explosives, narcotics, or both.

The shoe scanning system 80, which is powered by a power supply 96, includes a quadrupole resonance-based apparatus 88. The apparatus 88 includes quadrupole resonance transmitting and receiving subcomponents. For example, the apparatus 88 may include a metal detection transmitting coil 94, a quadrupole resonance transmitting/receiving coil 92, and transmitting/receiving electronics 90. The quadrupole resonance-based apparatus 88 interacts with a computer component 84 through a spectrometer 86. The shoe scanning system 80 also includes an Ethernet component 82, which also interacts with the computer component 84. Shoe placement sensors 98 will ensure that an accurate reading can be taken of the shoes of the individual being scanned.

The quadrupole resonance-based apparatus 88 is a similar technology to that employed in magnetic resonance imaging (MRI). It differs from MRI, however, in that it requires no applied magnetic field, thus greatly reducing system cost and eliminating hazards associated with strong magnetic fields. It also differs from MRI in that quadrupole resonance arises from the structure of the compound of interest and its crystal structure, thus making quadrupole resonance a chemically specific detection modality.

Quadrupole resonance detection may be performed by illuminating a volume under inspection with sequences of short pulses at the resonant frequency of the molecule being sought. For example, the quadrupole resonance transmitting/receiving coil 92 can direct sequences of short pulses at the resonant frequency of the active molecule in an explosives material at an individual's shoes. If that molecule is present, the molecule resonantly absorbs a tiny fraction of the incident radio-frequency energy and re-emits it in between the pulses. The detected emissions reveal the presence of the molecule.

Further, the shoe scanner system 80 may be used to detect metal on an individual's lower extremities. This may be accomplished through the transmission of pulses from the metal detection transmitting coil 94. Although the shoe scanner system 80 has been described as being a scanner for shoes, it should be appreciated that the same technology can be utilized to scan for explosives elsewhere on a person's body, such as his/her lower leg or midriff, for example. Further, the shoe scanner system 80 can customize the alerts to distinguish between a positive scan for explosives and a positive scan for metal.

A power module system 100, which may include a power conditioning component 102 and alternating current mains 104, supplies power to the power supplies 49, 58, 72, and 96.

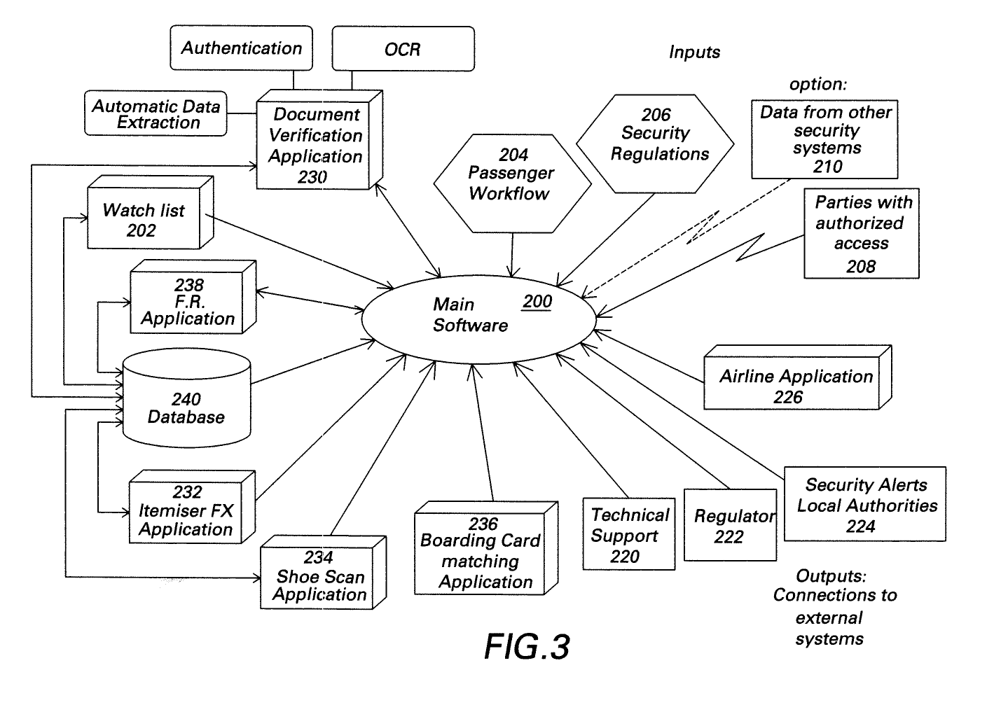

The kiosk 10 incorporates a suite of software applications, as schematically shown in FIG. 3, which interacts with a number of output functions and is interacted with by a number of input functions. For example, certain algorithms may be used to perform credential verification by comparing a live image of the traveler, acquired at the kiosk 10, with the photographic identification of the traveler which has been scanned from the traveler's identity documents. One such algorithm is a feature extraction algorithm which, given a photo ID and a live image of the traveler, will automatically fit landmark-based models to each image. A feature vector will be formed based on ratios of landmark positions and local image information such as histograms of gradients and responses to localized filter banks. Also, discriminative and/or generative models may be used for verification purposes by posing validation as a two-class problem (valid and invalid matches). Given sufficient training data in the form of valid and invalid matches, a form of machine learning will be used to automatically determine the optimal mechanism for discriminating between these two classes. This system will be trained using data collected from the kiosk 10. To take advantage of any additional information associated with the identification process, the training data may be partitioned into various classes, such as 34-38 year-old male with identification documents that are 4-6 years old. Since the generation of discriminative and/or generative models is completely automatic, thousands of data-driven verification engines can be manufactured in a systematic fashion. The resulting mechanism has the capacity for much greater specificity. The output of this system will be a match/no-match decision that will be transmitted to the main system.

An external watch list 202, passenger workflow 204, security regulations 206, authorized external parties with access 208, and data from other security systems 210 each may interact with the main software 200. Further, the main software 200 may interact with technical support 220, regulators 222, security alerts/local authorities 224, and airline applications 226.

Additionally, the main software 200 may have incoming and outgoing interaction with, for example, a document verification application 230, a boarding card matching application 236, and a facial recognition application 238 as described with reference to the document processing system 50 (FIG. 2). Further, the main software 200 may have incoming and outgoing interaction with a trace detection application 232 as described with reference to the trace detection system 60 (FIG. 2) and a shoe scan application 234 as described with reference to the shoe scanning system 80 (FIG. 2).

A database 240 also will interact with the main software 200, as well as with the watch list 202, the document verification application 230, the trace detection application 232, the shoe scan application 234, and the facial recognition application 238.

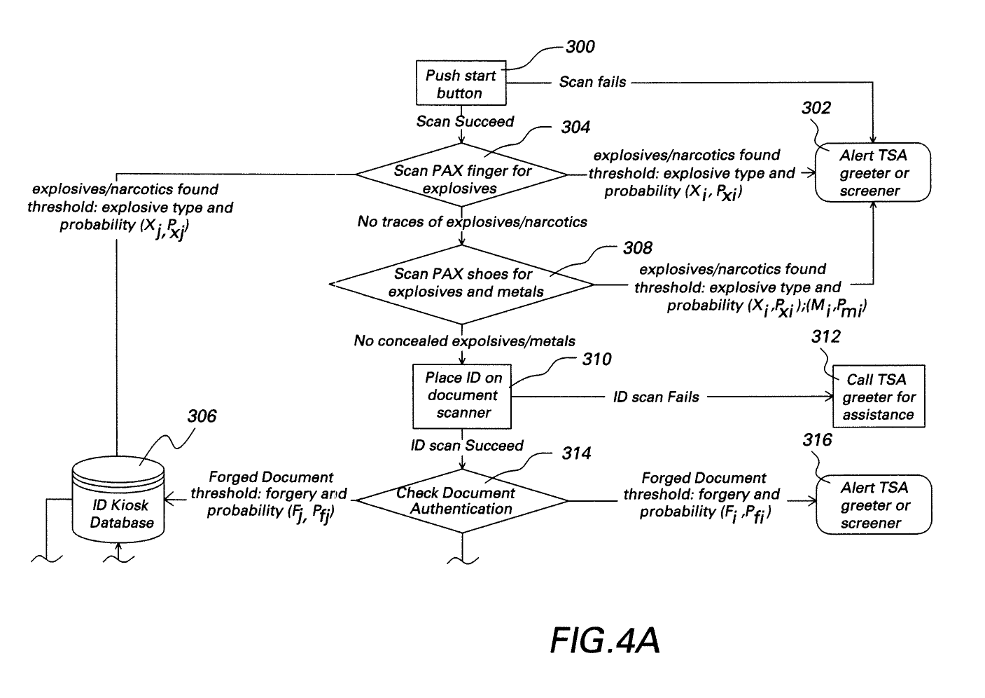

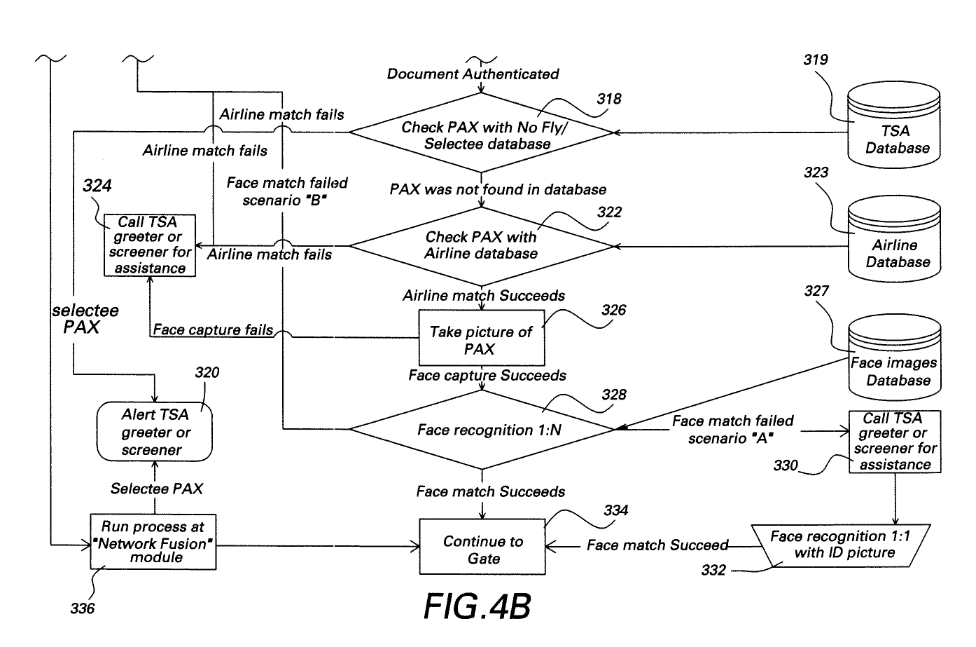

Referring specifically to FIGS. 4A and 4B, next will be explained a process for automatedly developing security-related characteristics for an individual in an aviation check point setting. The individual begins his/her interaction with the kiosk 10 by pushing a start button at Step 300. The start button is associated with the sampling wheel 70 within the trace detection system 60. If the scan from the trace detection system 60 fails, the individual will be directed at Step 302 to appropriate security personnel, such as, in an airport example, TSA greeters or screeners.

If the scan succeeds, the finger of the individual is scanned for explosives, narcotics, or other contraband at Step 304. If the scan detects a predetermined threshold amount of contraband trace, appropriate security personnel are alerted at Step 302 and the positive scan results are downloaded into a database of the kiosk 10 at Step 306. Information such as the amount of trace detected, the type of contraband, and the probability of a match to a type of contraband are all downloaded into the database, which may be database 240 (FIG. 3).

If no predetermined threshold amount of contraband is detected at Step 304, then the shoes of the individual are scanned at Step 308 by the shoe scanning system 80. If the shoe scan detects a predetermined threshold amount of contraband, such as explosives or metal objects, appropriate security personnel are alerted at Step 302 and the positive scan results are downloaded into the database 240 of the kiosk 10 at Step 306. Information such as the amount detected, the type of contraband, and the probability of a match to a type of contraband are all downloaded into the database 240.

If no predetermined threshold amount of contraband is detected from the shoe scan, then the individual is directed to place his/her identifying documentation on the document scanning bed 56 of the document processing system 50 at Step 310. If the ID scan fails, appropriate security personnel are summoned for assistance at Step 312. If, on the other hand, the scan is successful, the identifying document is checked for authentication at Step 314. If the ID scan detects that the identifying document is false or a forgery, appropriate security personnel are alerted at Step 316 and the positive scan results are downloaded into the database 240 of the kiosk 10 at Step 306. Information, such as how the document is false or a forgery and the probability that the document is false or a forgery, is downloaded into the database 240. In determining whether a document is false or a forgery, the ID scan takes into account whether the material of the document is incorrect, whether watermarks or other indicating layers are incorrect, and whether identifying information is inconsistent.

If the identifying document is authenticated, then, in at least the airport screening scenario, at Step 318 the individual is screened against the “No Fly/Selectee” database 319 supplied by the Transportation Security Administration. This database 319 may be associated with the watch list application 202 (FIG. 3). If the individual is found to be a match with the “No Fly/Selectee” database 319, then appropriate security personnel are alerted at Step 320.

If the individual is not found on the “No Fly/Selectee” database, then in at least the airport screening scenario the individual is checked against the airline database 323 at Step 322. The airline database 323 may be associated with the airline application 226 (FIG. 3). If a match to the airline database 323 fails, appropriate identification information is downloaded to the database 240 at Step 306 and appropriate security personnel are alerted at Step 324.

If the individual matches data in the airline database 323, then a photographic image of the individual is taken at the kiosk 10 at Step 326. That photographic image is compared to one or more photographic images of that individual that are found in a face images database, which may be associated with the facial recognition application 238 (FIG. 3). Obviously, as an individual travels more, each photographic image can be linked with other photographic images of that individual so that the instant photographic image can be compared, at Step 328, against numerous photographic images.

If the instant photographic image does not match either the document scanned at Step 310 or the photographic image(s) in the face images database 337, appropriate security personnel are summoned at Step 330 to perform a manual comparison between the photographic image and the identifying document held by that individual at Step 332. Alternatively, if an invalid match is encountered the two images can be transmitted to a central location for a manual comparison instead of requiring the physical presence of security personnel. If a facial match is determined, either at Step 328 or at Step 332, the individual is allowed to proceed through security to his/her gate at Step 334.

It should be appreciated that the alerting of appropriate security personnel at Steps 302, 312, 316, 320, and 324 may be invisible to the individual, allowing security personnel to observe the individual and track his movements should he/she decide to terminate interaction with the kiosk 10.

A network fusion module 336 processes all the potential probabilities, including the probability that contraband is on an individual's finger, that contraband or metal is in an individual's shoes, that a document is false or a forgery, along with information from the airline database 323, the TSA database 319, and the face images database 337. The network fusion module 336 outputs an overall probability directed toward whether the individual is who he/she claims to be, whether the individual is carrying any contraband, and whether there is a match between the individual's ticket and his/her identification documents. If the overall probability is above a certain threshold, then appropriate security personnel are alerted at Step 320. If the overall probability is below the threshold, then the individual is allowed to proceed through to the gate at Step 334.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A security checkpoint system, comprising:
a camera configured for obtaining a first photographic image of an individual;
a photographic image scanner configured for scanning a second photographic image; and
a comparator mechanism for comparing the first photographic image with the second photographic image to ascertain whether the second photographic image is of the individual.

2. The security checkpoint system of claim 1, wherein the comparator mechanism utilizes a discriminative or generative modeling.

3. The security checkpoint system of claim 1, further comprising a validation mechanism for validating the authenticity of an identifying document containing the second photographic image.

4. The security checkpoint system of claim 3, wherein the validation mechanism includes an illumination component.

5. The security checkpoint system of claim 4, wherein the illumination component comprises a near-infrared image analyzer or an ultraviolet image analyzer.

6. The security checkpoint system of claim 1, further comprising a shoe scanning mechanism for scanning shoes of the individual.

7. The security checkpoint system of claim 6, wherein the shoe scanning mechanism utilizes a quadrupole resonance-based apparatus.

8. The security checkpoint system of claim 6, wherein the shoe scanning mechanism comprises a metal detection apparatus.

9. The security checkpoint system of claim 1, further comprising a trace detection mechanism for detecting trace substances on the individual.

10. The security checkpoint system of claim 9, wherein the trace detection mechanism is configured to determine trace amounts of elements on one or more fingers of the individual.

11. The security checkpoint system of claim 10, wherein the trace detection mechanism is configured to determine trace amounts of one or more elements selected from the group consisting of explosives residue, gunpowder, and narcotic substances.

12. The security checkpoint system of claim 1, further comprising an interface configured for verifying the authenticity of the individual's travel ticket.

13. A kiosk for autonomous interface by an individual, said kiosk comprising:
an identification verification modality, comprising:
an image formation system for obtaining a first photographic image of an individual;
a scanning system for scanning a second photographic image; and
a comparison system for comparing the first photographic image with the second photographic image to ascertain whether the second photographic image is of the individual; and
at least one additional security-related modality.

14. The kiosk of claim 13, wherein the at least one additional security-related modality is selected from the group consisting of a trace detection system, a shoe scanning system, a document validation and authentication system, and a persons of interest system.

15. The kiosk of claim 14, wherein the trace detection system comprises an ion trap mobility spectrometer.

16. The kiosk of claim 14, wherein the shoe scanning system comprises a quadrupole resonance-based apparatus.

17. The kiosk of claim 14, wherein the document validation and authentication system comprises an illumination apparatus.

18. The kiosk of claim 17, wherein the illumination apparatus comprises a near-infrared image analyzer or an ultraviolet image analyzer.

19. A method for automatedly developing security-related characteristics for an individual, comprising:
obtaining a first photographic image of the individual;
scanning a second photographic image provided by the individual; and
comparing the first photographic image with the second photographic image to ascertain whether the second photographic image is of the individual.

20. The method of claim 19, wherein said obtaining a first photographic image comprises:
obtaining digital video of the individual; and
capturing the first photographic image from the digital video.

21. The method of claim 19, wherein said obtaining a first photographic image comprises:
obtaining analog video of the individual; and
converting the analog video into the first photographic image through an analog to digital converter.

22. The method of claim 19, wherein said obtaining a first photographic image comprises capturing a digital photographic image of the individual with a digital camera.

23. The method of claim 19, wherein said scanning a second photographic image comprises extracting a facial image of the individual from the second photographic image.

24. The method of claim 19, wherein said comparing comprises utilizing a discriminative model on the first and second photographic images.

25. The method of claim 19, further comprising detecting trace elements on the individual.

26. The method of claim 25, wherein said detecting comprises performing ion trap mobility spectrometry on the individual.

27. The method of claim 19, further comprising scanning the shoes of the individual.

28. The method of claim 27, wherein said scanning comprises performing quadrupole resonance on the shoes.

29. The method of claim 27, wherein said scanning comprises performing metal detection of the lower leg extremities.

30. The method of claim 19, further comprising validating and authentication a document containing the second photographic image.

31. The method of claim 30, wherein said validating and authenticating comprises illuminating the document.

32. The method of claim 31, wherein said illuminating comprises performing either near-infrared image analysis or ultraviolet image analysis on the document.
